(19) United States
(12) Patent Application Publication
(10) Pub. No.: US 2004/0194809 A1
(43) Pub. Date: Oct. 7, 2004

(54) Pipeline remediation method with wire rope pig

(76) Inventors: James R. Crawford, Lafayette, CA (US); Benton F. Baugh, Houston, TX (US)

Correspondence Address: Benton F. Baugh, 14626 Oak Bend, Houston, TX, 77079, US

(21) Appl. No.: 10/407,664

(22) Filed: Apr. 7, 2003

(51) Int. Cl. B08B 9/04

(52) U.S. Cl. 134/22.12; 134/22.14; 134/22.18; 134/22.19; 134/24; 134/34

(57) ABSTRACT

A method of remediating deposits which partially block a pipeline comprising providing a pig within said pipeline which sealingly engages the internal diameter of said pipeline, restraining the movement of said pig using a wire rope or similar means, pumping down the pipeline without taking return flow back up the pipeline, pumping through flow jets on the pig to increase the velocity of the flow to enhance the effectiveness of the remediation method.

### CROSS-REFERENCE TO RELATED APPLICATIONS

N/A

### STATEMENT REGARDING FEDERALLY SPONSORED RESEARCH OR DEVELOPMENT

N/A

### INCORPORATION-BY-REFERENCE OF MATERIAL SUBMITTED ON A COMPACT DISK

N/A

### BACKGROUND OF THE INVENTION

The field of this invention is that of tools used for the cleaning of pipelines, especially the long extended reach pipelines in offshore areas. As hot production crude is produced from the reservoirs below the ocean floor up to the wellhead equipment at the ocean floor and then through pipelines along the ocean floor, it is cooled by the relatively cool temperature of the ocean water. In deepwater, the temperature can be as cold as 35 degrees Fahrenheit.

A characteristic common to a majority of the oil produced is that there is a paraffin component to the oil which will deposit on the walls of the pipeline and become a solid at temperatures well above the 35 degrees Fahrenheit. In fact, some of the paraffins become solid at temperatures above 100 degrees Fahrenheit, and so can be deposited or plated on the internal diameters of the pipelines at any expected ambient temperature. The process is similar to discussions of blocking of the arteries of a human being, with a thicker coating building up with time. Some pipelines have become so plugged that more than 90% of the flow area is blocked with the waxes or paraffins.

Typically, the wall becomes layered with paraffin as the temperature of the oil goes below the solidification temperature of the particular paraffins in the produced fluids. The paraffins act as a sort of insulation to the flowing fluids in the pipeline, allowing it to maintain a higher temperature for a greater distance. The effect of this is to extend the distance along the pipeline which the paraffin is plating onto the internal diameter of the pipeline.

A common cure for the paraffin plating out on the internal diameter of the pipeline is to insert a pig into the flow stream and let the pig remove some of the paraffin. A pig is typically a cylindrical or spherical tool which will brush against the internal diameter of the pipeline in hopes of removing the deposited paraffins. In pipelines with a high incidence of deposited paraffins, a regular maintenance of pigs is normally prescribed as a preventative to pipeline blockage.

One problem with the pigs is that the deposited paraffins are relatively soft and contain a lot of oil. To some extent, the pigs actually compress the paraffins against the wall and squeeze the oil out, leaving a harder and stronger paraffin remaining.

A second problem is that when the paraffin layer on the internal diameter of the pipe is too thick, sloughing off may occur. If the paraffin starts to separate from the wall and continues, the pig begins to literally plow a block of paraffin ahead of itself. This will continue driving more and more paraffin off the wall of the pipeline until the pressure of the pipeline will no longer be able to move the mass. At that time you have full pipeline blockage, which cannot be moved by pressure from either end.

At that time the plug of paraffin must be removed by chemicals. Characteristically, the way chemicals are deployed to the location of the blockage is to use a string of coiled pipe or coiled tubing which is unreeled into the pipeline to provide a circulation path for the circulation of chemicals. As the end of the coiled tubing pipe reaches the location of the blockage, the chemicals are circulated either out the coiled tubing and back through the annulus outside of the coiled tubing and inside the pipeline, or the flow will be in the opposite direction.

### BRIEF SUMMARY OF THE INVENTION

The object of this invention is to provide a method for removing paraffin buildups on the inside of the pipeline, without allowing the free movement of a pig which tends to cause breaking the paraffin off the wall, thus causing blockages.

A second object of the present invention is to provide a method for causing a jetting action in a pipeline at the desired location for remediating wax buildup.

A third object of the present invention is to a method of providing a mechanical enhancement of chemical action at remote locations within a pipeline.

Another object of the present invention is to provide a means for remote rotary power within a pipeline without providing a secondary flow path.

Another object of the invention is to provide a means for controlling the back pressure on the pig by remotely electrically opening valving within the pig.

### BRIEF DESCRIPTION OF SEVERAL VIEWS OF THE DRAWINGS

FIG. 1 is a half section of the present invention showing the basic components of the wire rope pig.

FIG. 2 is a half section of the present invention showing a spinner cleaning nozzle attached.

FIG. 3 is a half section of the present invention showing cleaning brushes attached to the spinner cleaning nozzle.

FIG. 4 is a half section of the present invention shown going around a pipe bend.

### DETAILED DESCRIPTION OF THE INVENTION

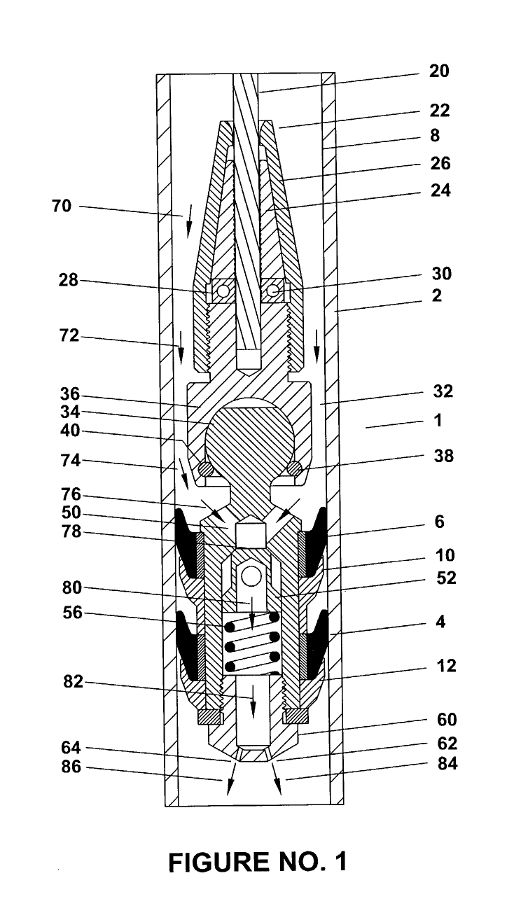

FIG. 1 shows a wire rope pig 1 inside a pipeline 2. The pig has two sealing cups 4 and 6 which sealingly engage the internal diameter 8 of the pipeline 2. The sealing cups are made of a relatively soft material, such as 70 durometer Buna N Hycar, which would be considered a durable rubber type product. The sealing cups 4 and 6 have backup rings 10 and 12 which may be made of steel or a plastic material such as Delrin or UHMW (ultra high molecular weight) plastics.

A wire rope 20 is attached to the end of the pig 22 of by means such as slips 24 within a bowl section 26. In this case a clamp ring 28 uses bolts 30 to tightly engage the wire rope to make sure the slips 24 work effectively. A variety of sockets such as lead filled and wedge types can be used. These are well known in the wire rope business.

In order to go around relatively sharp pipeline bends as will be seen later, a ball joint 32 is provided mid-way in the wire rope pig. A ball portion 34 is placed with a socket portion 36, and a wire 38 is pushed into a tangential hole (not shown) in the socket portion 36. As this wire 38 is pushed into the tangential hole, it fills the area between the ball portion 34 and a groove 40 cut into the socket portion 36. This provides for an economic assembly and retention method for the ball joint 32, but is not easy to disassembly. Other designs easier to disassemble will involve the addition of threaded connections.

Inside the body of the wire rope pig holes 50 are provided for circulation of fluids to a relief valve 52. Relief valve 52 is loaded on seat 54 by spring 56. Jet nozzle 60 is provided with nozzles 62, 64 and others not shown to cause a high velocity flows of the fluids and a directional jetting action.

When fluid is circulated along the annulus between the wire rope 20 and the internal diameter 8 of the pipeline, it flows along the path indicated by arrows 70, 72, 74, and 76 to the face 78 of relief valve 52. When enough pressure is provided to open the relief valve 52 against the spring 56, flow will continue along paths 80, 82, 84, and 86. The flow indicated by arrows 84 and 86 will be high velocity jetting, which will provide mechanical enhancement to the efficiency of the chemical cleaning action.

In a 4.5″ O.D. pipeline with a 3.826″ I.D. and a ⅝″ O.D. wire rope, the annular area will be approximately 11.19 square inches. Is the relief valve is set for 50 p.s.i., a force of about 660 lbs. will be provided to move the wire rope pig, and the attached wire rope. Any pressure over 50 p.s.i., i.e., 450 p.s.i. out of a 500 p.s.i. pumping pressure will be available to accelerate the flow across the jet nozzles.

Alternately, an actuated valve can be beneficially used in place spring operating the relief valve. The actuated valve can be actuated by an electric actuator such as a motor or a solenoid when an electric cable is used instead of the wire rope or in parallel to the wire rope. It can be actuated by a hydraulic cylinder when a hydraulic tube is utilized in addition to or in replacement for the wire rope. In this manner, the pig can be moved with the pressure without consideration for minimum pull due to the relief valve. When the unit is ready for the cleaning operations, the full differential pressure of the flow can be converted to jetting actions, rather than being used to keep the check valve open.

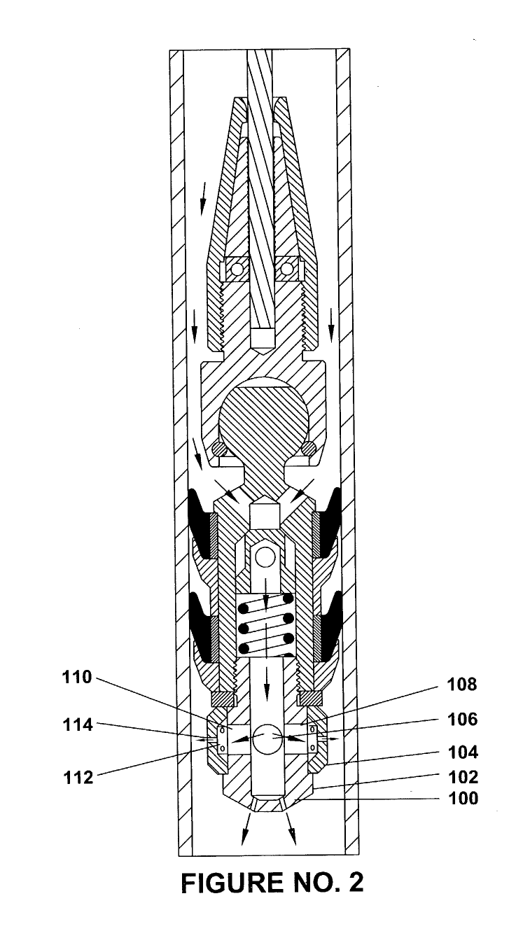

Referring now to FIG. 2, a wire rope pig is shown with an extended jet nozzle 100 having a shoulder 102 which retains a spinner 104. Holes 106, 108, and 110 deliver flow to an internal plenum 112 area below the spinner 104. Nozzles 114 are drilled tangentially with respect to the spinner 104 causing it to have a spinning action to thoroughly wash 100% of the internal area of the pipeline as it passes. This thorough washing of the bore will complement the forward jetting action of the nozzles on the jet nozzle 100.

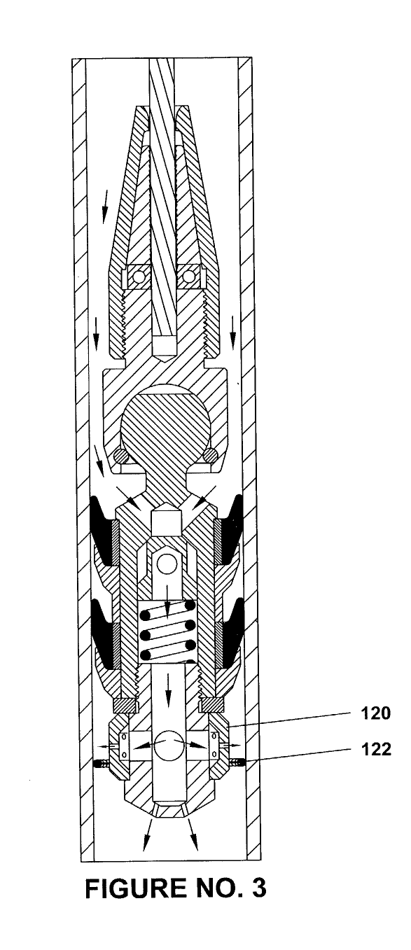

Referring now to FIG. 3, spinner 120 has brush pieces 122 attached. As the spinner spins, the brush pieces will rub the internal diameter of the pipeline to further enhance the effectiveness of the cleaning action. The brush pieces shown are a hard ball on the end of a piece of wire rope to give hardness and flexibility to the system. Alternate methods can be utilized, such as stiff wire brushes and hinged mechanical pieces which use centrifugal forces to apply them to the wall.

Alternate methods for causing the rotation of the spinner are anticipated. One method can be the addition of a small hydraulic motor which can drive the brushes more slowly than the spinner, but with more torque.

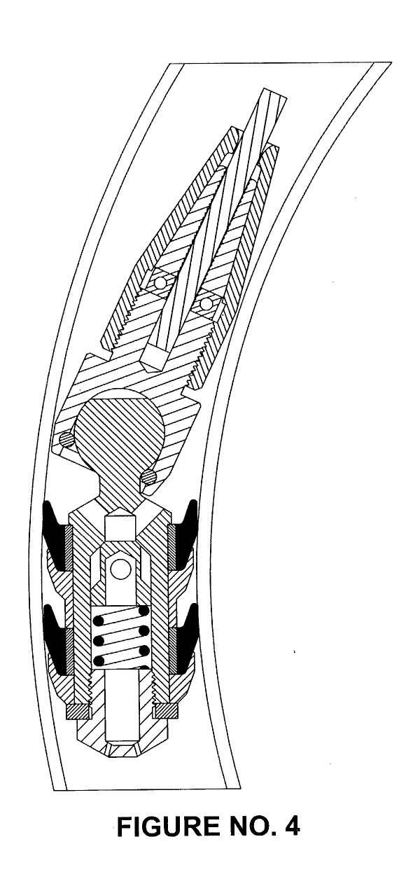

Referring now to FIG. 4, the wire rope pig 1 of FIG. 1 is shown in a pipeline with a bend which has an equivalent radius of 5d or 5 times the diameter of the pipeline. Although this is a difficult bend to navigate, it is the bend which will be in a large number of offshore pipelines.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

1. A method of remediating deposits within a pipeline comprising
providing a pig within said pipeline which sealingly engages the internal diameter of said pipeline,
restraining the movement of said pig,
pumping down the pipeline without taking return flow back up the pipeline,
pumping through flow restrictions on said pig to increase the velocity of the flow to enhance the effectiveness of the remediation.

2. The invention of claim 1, wherein the restraining of the movement of said pig is by holding back using a wire rope.

3. The invention of claim 1, wherein the restraining of the movement of said pig is by using an electric cable.

4. The invention of claim 1, wherein said flow restrictions to increase the velocity of said flow is done by providing jet nozzles.

5. The invention of claim 1, wherein the effectiveness of the remediation is improved by providing diesel fuel as the cleaning medium.

6. The invention of claim 1, wherein the effectiveness of the remediation is improved by providing Xylene as the cleaning medium.

7. The invention of claim 2, wherein said wire rope is attached to said pig using a slip member in a tapered bowl.

8. The invention of claim 7, further providing a secondary clamp to grip said wire rope in addition to the grip of said slip member.

9. The invention of claim 8, further providing said secondary clamp enhances the grip the said wire rope of said slip member.

10. The invention of claim 2, wherein said wire rope is attached to said pig using a wire rope socket.

11. The invention of claim 2, wherein said wire rope is attached to said pig using a wedge socket.

12. The invention of claim 1, further providing a swivel joint between said restraining means and said flow restrictions.

13. The invention of claim 1, further providing a relief valve to set the minimum pressure differential between the rear of the pig and the front of the pig to provide a motive force on the pig.

14. The invention of claim 1, further providing jet nozzles which rotate to enhance said remediation.

15. The invention of claim 14, wherein said jet nozzles rotate due to their own power.

16. The invention of claim 15, wherein said jet nozzles provide rotation power for a cleaning brush.

17. The invention of claim 14, wherein said jet nozzles are rotated by a motor.

18. The invention of claim 17, further providing said motor rotates a cleaning brush.

19. The invention of claim 1, wherein flow down the pipeline to said flow restrictions is controlled by an electric actuator.

20. The invention of claim 1, wherein the flow down the pipeline to said flfow restrictions is controlled by a hydraulically controlled actuator.
